(19) United States
(12) Patent Application Publication
(10) Pub. No.: US 2006/0155587 A1
(43) Pub. Date: Jul. 13, 2006

(54) Business methods, design

(76) Inventor: Robert D. Sparrow, Salt Lake City, UT (US)

Correspondence Address: Robert D. Sparrow, 4839 S. 2120 East, Salt Lake City, UT, 84117, US

(21) Appl. No.: 11/030,760

(22) Filed: Jan. 7, 2005

(51) Int. Cl. G06Q 40/00

(52) U.S. Cl. 705/4

(57) ABSTRACT

In compliance with 37CRF 1.72(b) the overall Business Method Design is to equip every vehicle insured, with the most safety factors available to prevent accidents, prevent thefts, and maintain the highest level of maintenance to every vehicle, so that efficiency and emissions always comply to EPA Rules and Regulations. In addition to our unique method of insuring vehicles, the insured will be able to get total vehicle sales and every kind of service from A to Z at the location of his General Insurance Agents sales and service office. Also, an insured will never have to drive a wrecked vehicle. The wrecked vehicle will be taken apart and the insured will have his vehicle replaced with a new or equivalent vehicle to his satisfaction.

### SUMMARY OF INSURANCE COMPANY AND INSURANCE HOLDING COMPANY INFORMATION AND METHOD OF DOING BUSINESS

1. The method for creating an overall business by utilizing a rule based system that allows the Insurance Company, through a Holding Company, ownership to do the following personalized business at one or several locations, supervised by a General Insurance Agent or designated certified managers or sub-insurance agents:
   a. Sell insurance coverage on auto, home, business in all categories including bonds, life, health/accident,
   b. Sell children's car seats and teach insured how to properly install the seat and properly place children in them, at cost. (No profit),
   c. Sell windshields, windows and service,
   d. Sell grease, oil jobs and parts,
   e. Sell vehicles, new and used,
   f. Sell mufflers, tires, alignment and brake parts,
   g. Sell auto parts at considerable discount to the insured,
   h. Sell kidnap locators for children, scouts, snowmobilers and animals,
   i. Sell first mortgages on homes,
   j. Finance automobiles,
   k. Sell credit cards,
   l. Sell cell phones, properly installed for use with no hands needed to hold the phone while driving or in the car,
   m. Rent vehicles to customers while their vehicle is being repaired,
   n. Have estate planning, funeral planning guides and “Life Planning” functions, all in person or on the internet,
   o. Sell a paid-up health and accident policy at age 65,
   p. Develop a profit sharing program for our insured's,
   q. Sell or list your real estate,
   r. Sell burial lots or arrange burial lot exchange, and
   s. Provide legal services.
   t. Provide a school for preventative medicine.

Within today's business environment, corporations spend millions annually planning for strategic initiatives and managing their corporate informational assets from loss or obsolescence. However, as individuals, most of us give little thought to planning our strategic future, much less truly dealing with the requirements of managing and protecting our personal information assets. THE NUWAY HOLDING METHOD business model is created to address the informational needs of individuals but perhaps more important, it was created to address the strategic nature of information that an individual requires to eliminate confusion and going from one place to another only to get more confusion and accomplishing nothing.

As individuals, our ability to address personal planning and informational needs is often times overlooked, misunderstood or simply not available to us. In some cases, the technology has not been employed to the degree needed to address the true needs of the individual (such is the case with emergency insurance information). NUWAY'S HOLDING METHOD business market recognizes these deficiencies and has developed new technical solutions, as well as, employing existing technologies to provide solutions within several key areas for the individual. These solutions include the development of an internet based information repository for the storage and retrieval of personal information, medical data, financial records, descriptions of personal assets and all digital data the individual wishes to store and maintain (scanned photographs, audio records, etc.). The utilization of the Internet provides for accessibility to the data from any communication device, the data is secured and maintained.

1. The General Insurance Agent which will be licensed to sell all lines of vehicles to his insured and others, will have a full line of Certified Mechanics to install the “STOP THEIF DEVICE” on any and all vehicles, including RV's, motor cycles, tractors, and any type of engine, to prevent theft, plus Nuway Holding will increase the warranty length of time or miles on the vehicles, if the insured uses our oil and greasing services of MOS2—Molybdenum disulfide.

2. Further, the General Insurance Agent will be licensed to sell “Kidnap Locator Devices” that can be attached to vehicles, children, dogs, cats, horses, cows, and an alarm will alert the owner or teacher when the individuals, vehicles, or animals are not in the proper area or place. This service will be an addition to the standard vehicle insurance coverage afforded to the insured's worldwide to report adverse events such as kidnappings, lost campers and hikers.

3. Further, the General Insurance Agent will be licensed to sell, trade, repair, and dismantle wrecked vehicles, and test the used parts from wrecked vehicles to make sure they can be sold as used or reconditioned parts to the public. These parts will all be tested, certified, and 100% guaranteed by Certified Mechanics before being sold to the public. These wrecked cars will be taken apart by trained and certified mechanics in schools located in different areas in the United States.

4. No insured will have to drive a wrecked vehicle, unless they want to. The wrecked vehicle will be replaced by equivalent, newer, or less costly than the vehicle he was driving at the time of the accident.

5. Included and incorporated into the insured's proof of insurance card, that is required to be in the vehicle at all times, will include an on track innovation (OTI) that has been selected to be the smart-chip provider for our insured. The technology that will be placed in the card will have necessary medical history that in the event of a serious physical damage to the person will have the blood type, allergies, occupation, personal doctor's name, phone number and beneficiary are immediately known so first aid can be administered without delay. This is a contactless smart card with a reader in your car for police or medical personnel so they can read the information immediately.
OTI's matched antenna technology allows the distance between the reader's antenna and the electronic circuitry, to vary from a few centimeters to as far as 35 meters. The OTI reader can be put in a secure area of the car to prevent vandalism and environmental interference, while only the passive extended antenna is exposed to the user, or eventually all police cars will have a reader with them.
